(19) United States
(12) Patent Application Publication
(10) Pub. No.: US 2022/0204894 A1
(43) Pub. Date: Jun. 30, 2022

(54) CLEANING PRODUCT

(71) Applicant: The Procter & Gamble Company, Cincinnati, OH (US)

(72) Inventors: Sophia Rosa EBERT, Mannheim (DE); Hayat EL KAH, Brussels (BE); Jeremie Robert Marcel GUMMEL, Ixelles (BE); Frank HULSKOTTER, Bad Dürkheim (DE); Dawid MARCZEWSKI, Limburgerhof (DE); Marc Rene Bert RENMANS, Strombeek-Bever (DE); Stefano SCIALLA, Rome (IT)

(21) Appl. No.: 17/536,177

(22) Filed: Nov. 29, 2021

(30) Foreign Application Priority Data
Dec. 28, 2020 (EP) 20217353.0

(51) Int. Cl. C11D 17/00; C11D 1/72; C11D 1/40; C11D 1/14; C11D 1/86; C11D 11/00; C11D 1/76

(52) U.S. Cl. CPC C11D 17/0008; C11D 1/72; C11D 1/40; C11D 1/76; C11D 1/86; C11D 11/0035; C11D 1/143

(57) ABSTRACT

The need for a cleaning product comprising a spray dispenser and a cleaning composition suitable for washing dishes which provides effective removal of both crystalline and polymerised grease, even at low surfactant and solvent levels, while also requiring less time and effort to clean and especially to rinse the dishes, regardless of hardness of the water used, is met by formulating the cleaning composition with a surfactant system comprising a non-alkoxylated esteramine.

### FIELD OF INVENTION The present invention relates to a cleaning product comprising a spray dispenser and a cleaning composition.

### BACKGROUND OF THE INVENTION

Traditionally manual dishwashing has been performed by filling a sink with water, adding a dishwashing detergent to create a soapy solution, immersing the soiled articles in the solution, scrubbing the articles and rinsing the washed articles to remove the remaining soils and remove the suds generated from the soapy solution from the washed articles. However, such full sink dishwashing methods are not particularly suitable for when a small number of articles need to be washed, or when the user prefers to wash the articles immediately after use, as can be the case for those living in smaller apartments where there is limited space to store dirty articles, or as in single person dwellings where it can take days for a sink-load of soiled articles such as dishes to accumulate.

As such, a high number of users prefer to do the washing under a running tap. A means of simplifying a wash process under running tap water is to dispense the detergent composition from a spray dispenser. The surfactant level in such cleaning compositions must be limited in order to provide a high-quality uniform spray mist. However, the user still desires good removal of soils, including hard to remove soils, as well as a rich foaming pattern.

Moreover, such spray dispensers provide a more efficient ways of cleaning dishware. Spray products are also well liked by consumers since they allow for direct and controlled application of the products during the dishwashing. However, a challenge for sprays for cleaning dishware is to avoid irritation from the over-spray mists during use. One cause of irritation is high levels of solvent that are typically added in order to ensure good cleaning of grease.

Crystalline grease soils and polymerised grease soils are particularly challenging to remove. Crystalline grease is grease which is solid at room temperature such as animal fats, and the like. Polymerised grease is grease which has been polymerised at high temperatures such as during baking. Typically, a high pH is needed to remove such polymerised grease. However, high pH affects surfactant packing, leading to less effective removal of crystalline grease.

In addition, it is desired to spend less time and effort washing dishes while still providing effective soil removal. The time needed to clean dishes can also be reduced by ensuring that suds and dirt residue are easily rinsed away. In other words, good initial sudsing is desired to indicate good cleaning efficacy but the suds should collapse rapidly during rinsing. Suds collapse has been found to be especially challenging when rinsing with soft water or water having low hardness since divalent ions such as calcium and magnesium ions sequester anionic surfactants and hence reduce sudsing during rinsing.

As such, a need remains for a cleaning product comprising a spray dispenser and a cleaning composition suitable for washing dishes which provides effective removal of both crystalline and polymerised grease, even at low surfactant and solvent levels, while also requiring less time and effort to clean and especially to rinse the dishes, regardless of hardness of the water used.

EP3118299A relates to a cleaning product comprising a spray dispenser and a cleaning composition suitable for spraying and foaming, the composition housed in the spray dispenser wherein the composition comprises: from 5 to 15% by weight of the composition of a surfactant system; and a selected glycol ether solvent and wherein the surfactant system and the glycol ether solvent are in a weight ratio of from 5:1 1 to 1:1. EP 3118301A relates to a cleaning product comprising a spray dispenser and a cleaning composition suitable for spraying and foaming, the composition housed in the spray dispenser wherein the composition comprises: 2 to 15% by weight of a surfactant system comprising an alkyl ethoxylated sulfate anionic surfactant and a co-surfactant selected from the group consisting of amphoteric surfactant, zwitteronic surfactant and mixtures thereof; and a selected glycol ether solvent. EP3162881A relates to a cleaning product comprising a spray dispenser and a cleaning composition suitable for spraying and foaming, the composition housed in the spray dispenser wherein the composition comprises: from 5 to 15% by weight of the composition of a surfactant system; and of a selected glycol ether solvent and a specific cyclic diamine. EP3170886A relates to a cleaning product comprising a spray dispenser and a cleaning composition suitable for spraying and foaming, the composition housed in the spray dispenser wherein the composition comprises a surfactant system, a glycol ether and a cleaning amine. EP3418360A relates to a sprayable cleaning composition, the sprayable cleaning composition including a surfactant system comprising an anionic surfactant and a co-surfactant selected from amphoteric and zwitterionic surfactants and mixtures thereof, a nonionic surfactant, which is a C6 alcohol ethoxylate comprising on average 1 to 10 EO, and a specific glycol ether solvent, wherein the surfactant system and the glycol ether solvent are in a weight ratio of from 5:1 to 1:5. EP3415603A relates to a laundry treatment composition housed in a container, wherein the container has a spray applicator and an internal chamber housing the laundry treatment composition and the laundry treatment composition is in contact with the spray applicator and the spray applicator is capable of spraying the laundry treatment composition into the environment external to the container upon activation of the spray applicator. EP2940115A relates to a cleaning composition comprising a cleaning amine which provides good cleaning, in particular good grease cleaning. WO2019/010368A relates to cleaning compositions that include non-alkoxylated esteramines, as well as to methods of preparation and use. While WO2019/010368 A discloses the use of such compositions for a variety of cleaning applications, including dish, the application is primarily directed to detergent compositions for use in laundry applications for removing greasy soils at low temperatures. Since WO2019/010368A is directed to the removal of grease primarily during laundry use, there is no mention of the benefit of the esteramines described therein, for improving the removal of polymerised or baked on grease. EP2940115A relates to a cleaning composition comprising a cleaning amine which provides good cleaning, in particular good grease cleaning. WO2019/010368A relates to cleaning compositions that include non-alkoxylated esteramines, as well as to methods of preparation and use. While WO2019/010368 A discloses the use of such compositions for a variety of cleaning applications, including dish, the application is primarily directed to detergent compositions for use in laundry applications for removing greasy soils at low temperatures. Since WO2019/010368A is directed to the removal of grease primarily during laundry use, there is no mention of the benefit of the esteramines described therein, for improving the removal of polymerised or baked on grease.

### SUMMARY OF THE INVENTION

The present invention relates to a cleaning product comprising a spray dispenser and a cleaning composition suitable for spraying, the composition is housed in the spray dispenser, wherein the composition comprises a surfactant system, wherein the surfactant system comprises: a non-alkoxylated esteramine, wherein the non-alkoxylated esteramine has the formula (I):

R¹—[(CH₂)_{c}—O(O)C—R²—(NH₂₋ₐ)ₐ—(R3)ₐ—(NH2)ₐ]_{b} (I)

wherein: R¹ is a branched or unbranched C₃-C₁₆ alkyl; each R² is independently selected from branched or unbranched C₁-C₁₂ alkyl; each R³ is independently selected from branched or unbranched C₁-C₁₂ alkyl; each index a is 0 or 1; the index b is an integer from 1 to 3; and each index c is independently 0 or 1.

### DETAILED DESCRIPTION OF THE INVENTION

Formulating the esteramine based technologies according to the invention, as described herein, has been found to deliver a cleaning product comprising a spray dispenser and a cleaning composition which is suitable for washing dishes which provides effective removal of both crystalline and polymerised grease, even at low surfactant and solvent levels, while also requiring less time and effort to clean and especially to rinse the dishes, regardless of hardness of the water used.

For the purpose of the present invention “dishware” encompasses all the items used to either cook or used to serve and eat food.

### Cleaning Product

The cleaning product comprises a spray dispenser and a cleaning composition suitable for spraying, the composition is housed in the spray dispenser.

By “spray dispenser” is herein meant a container comprising a housing to accommodate the composition and means to spray that composition. The preferred spraying means being a trigger spray. The composition foams when it is sprayed. Foaming is a property that users associate with cleaning therefore it is important that the composition of the invention foams to send the user the signal that the composition is cleaning.

### Cleaning composition

The cleaning composition is a hand dishwashing cleaning composition in liquid form.

Preferably, the pH of the composition is from 6 to 14, preferably from 7 to 12, or more preferably from 8.0 to 10, as measured neat at 20° C. The pH of the composition can be adjusted using pH modifying ingredients known in the art. At lower and higher pH, the non-alkoxylated esteramines of use in the present invention hydrolyze at a higher rate.

The reserve alkalinity can be from 0.1 to 1.0, more preferably from 0.1 to 0.5. Reserve alkalinity is herein expressed as grams of NaOH/100 ml of composition required to titrate product from a pH 7.0 to the pH of the finished composition. This pH and reserve alkalinity further contribute to the cleaning of tough food soils.

A pH meter (for example An Orion Model 720A) with a Ag/AgCl electrode (for example an Orion sure flow Electrode model 9172BN) is calibrated using standardized pH 7 and pH 10 buffers. A 100 g of a 10% solution in distilled water at 20° C. of the composition to be tested is prepared. The pH of the 10% solution is measured and the 100 g solution is titrated down to pH 7.0 using a standardized solution of 0.1 N of HCl. The volume of 0.1N HCl required is recorded in ml. The reserve alkalinity is calculated as follows:

Reserve Alkalinity=ml 0.1N HCl×0.1 (equivalent/liter)×Equivalent weight NaOH (g/equivalent)×10

The cleaning composition can be Newtonian or non-Newtonian. The composition can be shear thinning, in order to improve sprayability. In addition, a higher low-shear viscosity improves cling to vertical and inclined surfaces. Particularly suitable compositions for spraying have a high shear viscosity (10,000 s-1) of from 1.0 to 10 mPas, and a low shear viscosity (100 s-1) to high shear viscosity (10,000 s-1) ratio of from 10:1 to 1.5:1, measured at 20° C. using the method defined below. In order to improve the viscosity profile, the composition can comprise a thickener, such as xanthan gum.

### Surfactant System

The composition comprises a surfactant system. The surfactant system comprises a non-alkoxylated esteramine. The composition can comprise from 2.0% to 25%, preferably from 5.0% to 20%, more preferably from 8.0% to 18% by weight of the composition of the surfactant system.

The surfactant system can further comprise a surfactant selected from the group consisting of: anionic surfactant, nonionic surfactant, and mixtures thereof, and/or a co-surfactant selected from the group consisting of: amphoteric surfactant, zwitterionic surfactant, and mixtures thereof.

### Non-Alkoxylated Esteramine

The surfactant system comprises at least one non-alkoxylated esteramine and/or its salt thereof. It has been found that the non-alkoxylated esteramines of use in the present invention boost both polymerized and crystalline grease cleaning performance of cleaning products, especially liquid hand dishwashing detergents, as well as enable faster rinsing of the suds.

The surfactant system may include from 0.1% to 10%, preferably from 0.3% to 5.0%, more preferably from 0.5% to 2.0, by weight the composition, of a non-alkoxylated esteramine, wherein the weight percentage of the non-alkoxylated esteramine is calculated based on the mass of the fully ionized cation of the non-alkoxylated esteramine, whether present in its salt form or non-salt form, and excluding the weight of the counterions.

The non-alkoxylated esteramine has the Formula I:

R¹—[(CH₂)_{c}—O(O)C—R²—(NH₂₋ₐ)—(R3)ₐ—(NH2)ₐ]_{b} (I)
wherein:
R¹ is a branched or unbranched C₃-C₁₆ alkyl;
each R² is independently selected from branched or unbranched C₁-C₁₂ alkyl;
each R3 is independently selected from branched or unbranched C₁-C₁₂ alkyl;
each index a is 0 or 1, preferably 0;
the index b is an integer from 1 to 3, preferably 1 or 2, more preferably 1; and
each index c is independently 0 or 1, preferably 1.

The non-alkoxylated esteramine is preferably at least partially in its salt form, for example where one or more NH2 groups are protonated (e.g., NH₃⁺) and the salt includes an A⁻ group, where the A⁻ group is a suitable charge-balancing counterion. Whether the non-alkoxylated esteramine is in its non-salt form, at least partially in its salt form, or fully in its salt form typically depends on the pH of the composition. A⁻ may be an anion derived from an acid selected from the group consisting methanesulfonic acid, hydrochloric acid, hydrobromic acid, sulfuric acid, phosphoric acid, toluene sulfonic acid, citric acid, lactic acid, C12-C18 fatty acid, alkyl benzene sulfonic acids, alkyl sulphonic acids, alkyl sulfuric acids, alkyl ethyoxysulfuric acids, alkoxylated or non-alkoxylated copolymers of acrylic acid and maleic acid, and mixtures thereof. A⁻ is preferably selected from alkyl sulfuric acids, alkyl sulfonic acids, alkyl benzene sulfonic acids, and mixtures thereof, most preferably alkyl sulfuric acid. The alkyl chain of the acid is preferably the same as R1 of formula (I) of the non-alkoxylated esteramine.

In the non-alkoxylated esteramine according to Empirical Formula I, the le may be a C₃-C₁₀ alkyl, more preferably a C₃-C₈ alkyl. If c is 1, R¹ is preferably linear. If c is 0, R¹ is preferably branched, more preferably branched at the 2-position, counting from the carbon atom bound to the oxygen atom of the ester-group. R¹ can be substituted or unsubstituted.

Each R² may be independently selected from branched or unbranched C₂-C₈ alkyl, more preferably C₂-C₆ unbranched alkyl. R² can be substituted or unsubstituted.

Each R³, if present, may be independently selected from C₁-C₆, more preferably C₁-C₄. R³ can be substituted or unsubstituted.

R¹, R², and R³ are preferably unsubstituted alkyls. If substituted, the substitution is preferably selected from the group consisting of: —OH, ketone, ether, phenyl, phenol, carbonyl, thiol, and mixtures thereof, but preferably does not result in any additional functionality. Additional amines are not suitable substitutions.

The non-alkoxylated esteramine may be selected from a compound having a structure as shown in structures A to G below, or mixtures thereof, with the non-alkoxylated esteramine being present in its salt form or non-salt form and, if present A⁻ is a suitable charge-balancing anion, as described above. The compounds are shown below in their salt forms, but it is recognized that the esteramine may be present in the compositions of the present disclosure in non-salt form, or in mixtures of salt and non-salt forms, as defined by the pH of the respective formulation or wash solutions thereof.

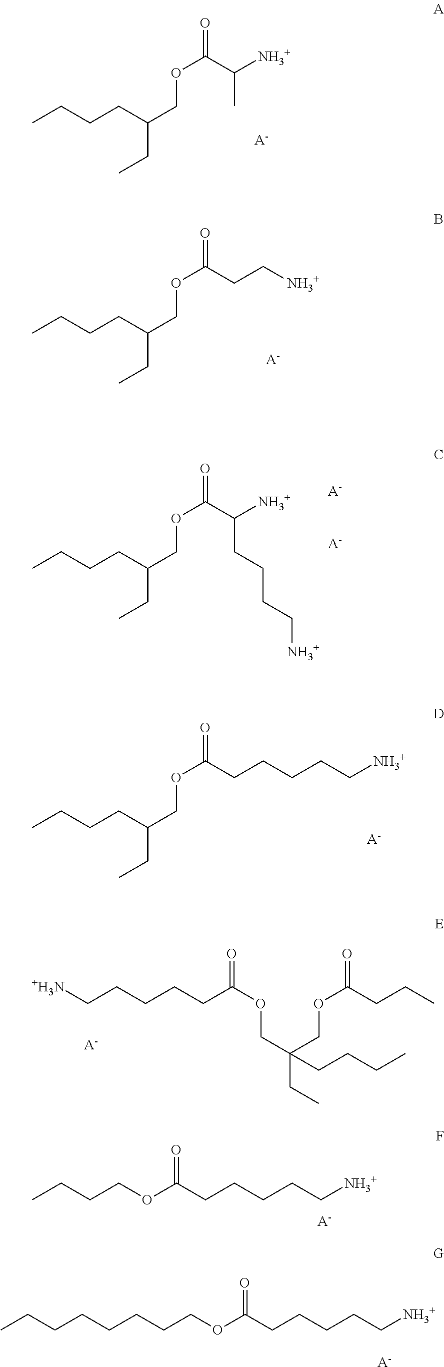

The non-alkoxylated alcohol may be esterified by any suitable means, such as described in more detail below.

Esterification. Suitable esteramines can also be synthesised via esterification of a non-ethoxylated alcohol. Suitable methods of synthesis are disclosed in WO2019007750 and WO2019007754. The non-alkoxylated alcohol may be at least partially esterified with at least one acid selected from the group consisting of alanine, aspartic acid, cysteine, glycine, isoleucine, leucine, methionine, phenylalanine, serine, threonine, tyrosine, valine, aminohexanoic acid, and acids of Formula (V)

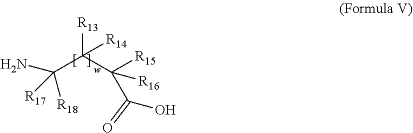

with w being an integer from 0 to 12,

R₁₃ and R₁₄ independently for each repetition unit w being selected from the group consisting of H, linear alkyl, branched alkyl, and cycloalkyl;

R₁₅, R₁₆, R₁₇, and R₁₈ being selected from the group consisting of H, linear alkyl, branched alkyl, and cycloalkyl.

The esterification reaction may be performed as known in the art, for instance, as disclosed in WO2019110371.

The present disclosure also contemplates combinations of at least two (different) esteramines as presented herein. The present disclosure also relates to combinations of the embodiments described above in combination with similar, but alkoxylated, compounds, e.g., alkoxylated esteramines, such as disclosed in WO2019007750. These compounds may be present in low amounts, e.g., less than about 5% by weight of the total esteramines present in the composition.

### Anionic Surfactant

In particular, the surfactant system can comprise a surfactant which is an anionic surfactant selected from the group consisting of: linear alkyl benzene sulfonate, alkyl sulphated anionic surfactant, and mixtures thereof, preferably wherein the anionic surfactant comprises an alkyl sulfate anionic surfactant, more preferably wherein the anionic surfactant comprises an alkoxylated alkyl sulfate anionic surfactant.

The surfactant system can comprise the alkyl sulphate anionic surfactant at a level of from 2.0% to 12%, preferably from 2.5% to 10%, more preferably from 3.0% to 7.5% by weight of the composition.

The anionic surfactant can comprise at least 70% by weight of the anionic surfactant of alkyl sulfate surfactant. The anionic surfactant preferably comprises at least 80%, preferably at least 90%, preferably 100% by weight of the anionic surfactant of alkyl sulfate surfactant. The alkyl sulfate surfactant can be alkoxylated or free of alkoxylation.

The mol average alkyl chain length of the alkyl sulfate anionic surfactant can be from 8 to 18, preferably from 10 to 14, more preferably from 12 to 14, most preferably from 12 to 13 carbon atoms, in order to provide a combination of improved grease removal and enhanced speed of cleaning.

When alkoxylated, the alkyl sulfate anionic surfactant typically has an average degree of alkoxylation of from 1.0 to 5.0 , preferably 2.0 to 4.0, most preferably from 2.5 to 3.5, in order to improve low temperature physical stability and improve grease cleaning of the compositions of the present invention.

The average degree of alkoxylation is the mol average degree of alkoxylation (i.e., mol average alkoxylation degree) of all the alkyl sulfate anionic surfactant. Hence, when calculating the mol average alkoxylation degree, the mols of non-alkoxylated sulfate anionic surfactant are included:

Mol average alkoxylation degree=(x1*alkoxylation degree of surfactant 1+x2*alkoxylation degree of surfactant 2+. . . )/(x1+x2+. . . )

wherein x1, x2, . . . are the number of moles of each alkyl (or alkoxy) sulfate anionic surfactant of the mixture and alkoxylation degree is the number of alkoxy groups in each alkyl sulfate anionic surfactant.

Preferred alkyl alkoxy sulfates are alkyl ethoxy sulfates.

The alkyl sulfate anionic surfactant can be linear or branched.

Compositions comprising linear alkyl sulfate anionic surfactants provide improved grease cleaning.

When branched, alkyl sulfate anionic surfactant can have a weight average degree of branching of more than 10%, preferably more than 20%, more preferably more than 30%, even more preferably between 30% and 60%, most preferably between 30% and 50%. The alkyl sulfate anionic surfactant can comprise at least 5%, preferably at least 10%, most preferably at least 25%, by weight of the alkyl sulfate anionic surfactant, of branching on the C2 position (as measured counting carbon atoms from the sulfate group for non-alkoxylated alkyl sulfate anionic surfactants, and the counting from the alkoxy-group furthest from the sulfate group for alkoxylated alkyl sulfate anionic surfactants). More preferably, greater than 75%, even more preferably greater than 90%, by weight of the total branched alkyl content consists of C1-C5 alkyl moiety, preferably C1-C2 alkyl moiety. It has been found that formulating the inventive compositions using alkyl sulfate surfactants having the aforementioned degree of branching results in improved low temperature stability. Such compositions require less solvent in order to achieve good physical stability at low temperatures. As such, the compositions can comprise lower levels of organic solvent, of less than 5.0% by weight of the cleaning composition of organic solvent, while still having improved low temperature stability. Higher surfactant branching also provides faster initial suds generation, but typically less suds mileage as well as less strong grease cleaning. The weight average branching, described herein, has been found to provide improved low temperature stability, initial foam generation.

The weight average degree of branching for an anionic surfactant mixture can be calculated using the following formula:

Weight average degree of branching (%)=[(x1*wt % branched alcohol 1 in alcohol 1+x2*wt % branched alcohol 2 in alcohol 2+. . . )/(x1+x2+. . . )]*100

wherein x1, x2, . . . are the weight in grams of each alcohol in the total alcohol mixture of the alcohols which were used as starting material before (alkoxylation and) sulfation to produce the alkyl (alkoxy) sulfate anionic surfactant. In the weight average degree of branching calculation, the weight of the alkyl alcohol used to form the alkyl sulfate anionic surfactant which is not branched is included.

The weight average degree of branching and the distribution of branching can typically be obtained from the technical data sheet for the surfactant or constituent alkyl alcohol. Alternatively, the branching can also be determined through analytical methods known in the art, including capillary gas chromatography with flame ionisation detection on medium polar capillary column, using hexane as the solvent. The weight average degree of branching and the distribution of branching is based on the starting alcohol used to produce the alkyl sulfate anionic surfactant.

Suitable counterions include alkali metal cation earth alkali metal cation, alkanolammonium or ammonium or substituted ammonium, but preferably sodium.

Suitable examples of commercially available alkyl sulfate anionic surfactants include, those derived from alcohols sold under the Neodol® brand-name by Shell, or the Lial®, Isalchem®, and Safol® brand-names by Sasol, or some of the natural alcohols produced by The Procter & Gamble Chemicals company. The alcohols can be blended in order to achieve the desired chain length distribution and branching.

The performance can be affected by the width of the alkoxylation distribution of the alkoxylated alkyl sulfate anionic surfactant, including grease cleaning, sudsing, low temperature stability and viscosity of the finished product. The alkoxylation distribution, including its broadness can be varied through the selection of catalyst and process conditions when making the alkoxylated alkyl sulfate anionic surfactant.

If ethoxylated alkyl sulfate is present, without wishing to be bound by theory, through tight control of processing conditions and feedstock material compositions, both during alkoxylation especially ethoxylation and sulfation steps, the amount of 1,4-dioxane by-product within alkoxylated especially ethoxylated alkyl sulfates can be reduced. Based on recent advances in technology, a further reduction of 1,4-dioxane by-product can be achieved by subsequent stripping, distillation, evaporation, centrifugation, microwave irradiation, molecular sieving or catalytic or enzymatic degradation steps. Processes to control 1,4-dioxane content within alkoxylated/ethoxylated alkyl sulfates have been described extensively in the art. Alternatively 1,4-dioxane level control within detergent formulations has also been described in the art through addition of 1,4-dioxane inhibitors to 1,4-dioxane comprising formulations, such as 5,6-dihydro-3-(4-morpholinyl)-1-[4-(2-oxo-1-piperidinyl)-phenyl]-2-(1-H)-pyridone, 3-α-hydroxy-7-oxo stereoisomer-mixtures of cholinic acid, 3-(N-methyl amino)-L-alanine, and mixtures thereof.

The surfactant system may comprise further anionic surfactant, including sulfonate such as HLAS, or sulfosuccinate anionic surfactants. However, the composition preferably comprises less than 30%, preferably less than 15%, more preferably less than 10% by weight of the surfactant system of further anionic surfactant. Most preferably, the surfactant system comprises no further anionic surfactant, other than the alkyl sulfate anionic surfactant.

The anionic surfactant is considered to comprise any anionic surfactant present as a counterion to the non-alkoxylated esteramine.

### Nonionic Surfactant

The surfactant system can comprise a nonionic surfactant. Suitable nonionic surfactants include alkoxylated alcohol nonionic surfactants, alkyl polyglucoside nonionic surfactants, and mixtures thereof, most preferably a blend of alkyl alkoxylate nonionic surfactant and alkyl polyglucoside surfactant.

### Alkoxylated Alcohol Nonionic Surfactant

The nonionic surfactant can comprise an alkyl alkoxylate nonionic surfactant, wherein the alkyl alkoxylate nonionic surfactant is present at a level of from 0.5% to 10%, more preferably from 1.0% to 5.0%, most preferably from 1.5% to 4.0% by weight of the composition

Suitable non-ionic surfactants include alkyl alkoxylate non-ionic surfactants, more preferably alkyl ethoxylate non-ionic surfactants. Suitable nonionic surfactants include the condensation products of aliphatic alcohols with from 1 to 25 moles of ethylene oxide. The alkyl chain of the aliphatic alcohol can either be straight or branched, primary or secondary, preferably straight, natural or synthetically derived, preferably comprising on average from 6 to 20 carbon atoms.

Preferably the nonionic surfactant can be a linear or branched low cut alcohol alkoxylate non-ionic surfactant with an average alkyl carbon chain length of C10 and below and comprising on average from 3 to 7 alkoxy preferably ethoxy (EO) groups, more preferably a linear C6 alcohol ethoxylate non-ionic surfactant comprising on average from 3 to 7 EO, preferably from 4 to 6 EO, more preferably 5 EO groups. A particularly preferred low cut alcohol ethoxylate is commercially available from the BASF company under the Lutensol CS6250 or Emulan HE50 tradenames, representing a linear C6 ethoxylated alcohol with on average 5 EO groups. These low cut alcohol ethoxylate nonionic surfactants have been found to improve dense foam creation upon spraying, controlling particle aerosolization and stinging impacts accordingly.

### Alkyl Polyglucoside Nonionic Surfactant

The compositions of the present invention can comprise alkyl polyglucoside (“APG”) surfactant. The addition of alkyl polyglucoside surfactants have been found to improve sudsing beyond that of comparative nonionic surfactants such as alkyl ethoxylated surfactants. If present, the alkyl polyglucoside can be present in the surfactant system at a level of from 2.0% to 12%, preferably from 2.5% to 10%, more preferably from 3.0% to 7.5% by weight of the composition.

For improved crystalline grease removal, the alkyl polyglucoside surfactant can have a number average alkyl carbon chain length between 8 and 18, preferably between 10 and 16, most preferably between 12 and 14, with an average degree of polymerization of between 0.1 and 3.0 preferably between 1.0 and 2.0, most preferably between 1.2 and 1.6.

For improved initial sudsing, the alkyl polyglucoside surfactant can have a number average alkyl carbon chain length between 8 and 18, preferably between 8 and 14, most preferably between 8 and 10, with an average degree of polymerization of between 0.1 and 3.0 preferably between 1.0 and 2.0, most preferably between 1.2 and 1.6.

C8-C18 alkyl polyglucosides are commercially available from several suppliers (e.g., Simusol® surfactants from Seppic Corporation; and Glucopon® 600 CSUP, Glucopon® 650 EC, Glucopon® 600 CSUP/MB, and Glucopon® 650 EC/MB, from BASF Corporation).

### Co-Surfactant

In order to improve surfactant packing and hence improve suds mileage, the surfactant system can comprise a co-surfactant. The surfactant system can comprise a co-surfactant selected from the group consisting of: amphoteric surfactant, zwitterionic surfactant, and mixtures thereof.

The composition can comprise from 0.5% to 5.0%, preferably from 1.0% to 4.5%, more preferably from 2.0% to 4.0% by weight of the cleaning composition of the co-surfactant.

The surfactant system of the cleaning composition of the present invention preferably comprises from 10% to 50%, preferably from 15% to 45%, more preferably from 20% to 40%, by weight of the surfactant system of a co-surfactant.

The co-surfactant can be an amphoteric surfactant which is selected from amine oxide surfactant, more preferably wherein the amine oxide surfactant is selected from the group consisting of: alkyl dimethyl amine oxide, alkyl amido propyl dimethyl amine oxide, and mixtures thereof.

The amine oxide surfactant can be linear or branched, though linear are preferred. Suitable linear amine oxides are typically water-soluble, and characterized by the formula R1—N(R2)(R3) O wherein R1 is a C8-18 alkyl, and the R2 and R3 moieties are selected from the group consisting of C1-3 alkyl groups, C1-3 hydroxyalkyl groups, and mixtures thereof. For instance, R2 and R3 can be selected from the group consisting of: methyl, ethyl, propyl, isopropyl, 2-hydroxethyl, 2-hydroxypropyl and 3-hydroxypropyl, and mixtures thereof, though methyl is preferred for one or both of R2 and R3. The linear amine oxide surfactants in particular may include linear C10-C18 alkyl dimethyl amine oxides and linear C8-C12 alkoxy ethyl dihydroxy ethyl amine oxides.

Preferably, the amine oxide surfactant is selected from the group consisting of: alkyl dimethyl amine oxide, alkyl amido propyl dimethyl amine oxide, and mixtures thereof. Alkyl dimethyl amine oxides are particularly preferred, such as C8-18 alkyl dimethyl amine oxides, or C10-16 alkyl dimethyl amine oxides (such as coco dimethyl amine oxide). Suitable alkyl dimethyl amine oxides include C10 alkyl dimethyl amine oxide surfactant, C10-12 alkyl dimethyl amine oxide surfactant, C12-C14 alkyl dimethyl amine oxide surfactant, and mixtures thereof. C12-C14 alkyl dimethyl amine oxide are particularly preferred.

Alternative suitable amine oxide surfactants include mid-branched amine oxide surfactants. As used herein, “mid-branched” means that the amine oxide has one alkyl moiety having n1 carbon atoms with one alkyl branch on the alkyl moiety having n2 carbon atoms. The alkyl branch is located on the a carbon from the nitrogen on the alkyl moiety. This type of branching for the amine oxide is also known in the art as an internal amine oxide. The total sum of n1 and n2 can be from 10 to 24 carbon atoms, preferably from 12 to 20, and more preferably from 10 to 16. The number of carbon atoms for the one alkyl moiety (n1) is preferably the same or similar to the number of carbon atoms as the one alkyl branch (n2) such that the one alkyl moiety and the one alkyl branch are symmetric. As used herein “symmetric” means that |n1-n2| is less than or equal to 5, preferably 4, most preferably from 0 to 4 carbon atoms in at least 50 wt %, more preferably at least 75 wt % to 100 wt % of the mid-branched amine oxides for use herein. The amine oxide further comprises two moieties, independently selected from a C1-3 alkyl, a C1-3 hydroxyalkyl group, or a polyethylene oxide group containing an average of from about 1 to about 3 ethylene oxide groups. Preferably, the two moieties are selected from a C1-3 alkyl, more preferably both are selected as C1 alkyl.

Alternatively, the amine oxide surfactant can be a mixture of amine oxides comprising a mixture of low-cut amine oxide and mid-cut amine oxide. The amine oxide of the composition of the invention can then comprises:
a) from about 10% to about 45% by weight of the amine oxide of low-cut amine oxide of formula R1R2R3AO wherein R1 and R2 are independently selected from hydrogen, C1-C4 alkyls or mixtures thereof, and R3 is selected from C10 alkyls and mixtures thereof and
b) from 55% to 90% by weight of the amine oxide of mid-cut amine oxide of formula R4R5R6AO wherein R4 and R5 are independently selected from hydrogen, C1-C4 alkyls or mixtures thereof, and R6 is selected from C12-C16 alkyls or mixtures thereof

In a preferred low-cut amine oxide for use herein R3 is n-decyl, with preferably both R1 and R2 being methyl. In the mid-cut amine oxide of formula R4R5R6AO, R4 and R5 are preferably both methyl.

Preferably, the amine oxide comprises less than about 5%, more preferably less than 3%, by weight of the amine oxide of an amine oxide of formula R7R8R9AO wherein R7 and R8 are selected from hydrogen, C1-C4 alkyls and mixtures thereof and wherein R9 is selected from C8 alkyls and mixtures thereof. Limiting the amount of amine oxides of formula R7R8R9AO improves both physical stability and suds mileage.

Alternatively, or in addition, the co-surfactant can be a zwitterionic surfactant. Suitable zwitterionic surfactants include betaine surfactants. Such betaine surfactants includes alkyl betaines, alkylamidobetaine, amidazoliniumbetaine, sulfobetaine (INCI Sultaines) as well as the phosphobetaine, and preferably meets formula (I):

R¹—[CO—X(CH₂)ₙ]ₓ—N⁺(R²)(R₃)—(CH₂)ₘ—[CH(OH)—CH₂]_{y}—Y⁻

wherein in formula (I),

R1 is selected from the group consisting of: a saturated or unsaturated C6-22 alkyl residue, preferably C8-18 alkyl residue, more preferably a saturated C10-16 alkyl residue, most preferably a saturated C12-14 alkyl residue;

X is selected from the group consisting of: NH, NR4 wherein R4 is a C1-4 alkyl residue, O, and S,
n is an integer from 1 to 10, preferably 2 to 5, more preferably 3,
x is 0 or 1, preferably 1,

R2 and R3 are independently selected from the group consisting of: a C1-4 alkyl residue, hydroxy substituted such as a hydroxyethyl, and mixtures thereof, preferably both R2 and R3 are methyl,

m is an integer from 1 to 4, preferably 1, 2 or 3,

y is 0 or 1, and

Y is selected from the group consisting of: COO, SO3, OPO(OR5)O or P(O)(OR5)O, wherein R5 is H or a C1-4 alkyl residue.

Preferred betaines are the alkyl betaines of formula (Ia), the alkyl amido propyl betaine of formula (Ib), the sulfo betaines of formula (Ic) and the amido sulfobetaine of formula (Id):

R¹—N⁺(CH₃)₂—CH₂COO^{—(IIa)}

R¹—CO—NH—(CH₂)₃—N⁺(CH₃)₂—CH₂COO⁻ (IIb)

R¹—N⁺(CH₃)₂—CH₂CH(OH)CH₂SO₃⁻ (IIc)

R¹—CO—NH—(CH₂)₃—N⁺(CH₃)₂—CH₂CH(OH)CH₂SO₃⁻ (IId)

in which R1 has the same meaning as in formula (I). Particularly preferred are the carbobetaines [i.e. wherein Y—=COO— in formula (I)] of formulae (Ia) and (Ib), more preferred are the alkylamidobetaine of formula (Ib).

Suitable betaines can be selected from the group consisting or [designated in accordance with INCI]: capryl/capramidopropyl betaine, cetyl betaine, cetyl amidopropyl betaine, cocamidoethyl betaine, cocamidopropyl betaine, cocobetaines, decyl betaine, decyl amidopropyl betaine, hydrogenated tallow betaine/amidopropyl betaine, isostearamidopropyl betaine, lauramidopropyl betaine, lauryl betaine, myristyl amidopropyl betaine, myristyl betaine, oleamidopropyl betaine, oleyl betaine, palmamidopropyl betaine, palmitamidopropyl betaine, palm-kernelamidopropyl betaine, stearamidopropyl betaine, stearyl betaine, tallowamidopropyl betaine, tallow betaine, undecylenamidopropyl betaine, undecyl betaine, and mixtures thereof. Preferred betaines are selected from the group consisting of: cocamidopropyl betaine, cocobetaines, lauramidopropyl betaine, lauryl betaine, myristyl amidopropyl betaine, myristyl betaine, and mixtures thereof. Cocamidopropyl betaine is particularly preferred.

### Further Ingredients

The composition can comprise further ingredients such as those selected from: organic grease cleaning solvents, chelants and/or builders, shear thinning rheology modifier, cyclic polyamines, hydrotropes, other adjunct ingredients such as those described herein, and mixtures thereof.

### Organic Grease Cleaning Solvent

For improved penetration and removal of crystalline grease, the composition comprises an organic grease cleaning solvent. Suitable organic grease cleaning solvents can be selected from the group consisting of: glycol ether solvents, alcohol solvents, ester solvents, and mixtures thereof, with glycol ether solvents being preferred as they are particularly effective when used in combination with the surfactant system of the invention to remove crystalline grease, and can also improve sudsing.

Since the non-alkoxylated esteramine results in improved grease removal, less solvent is required. As such, the spray composition comprising the non-alkoxylated esteramine can be formulated using lower levels of solvent or even no solvent. The resultant compositions can result in a spray mist which is less irritating. The composition can comprise from 0.1% to 8.0%, preferably from 1.0% to 7.0%, more preferably from 2.0% to 6.0% by weight of the cleaning composition of such organic grease cleaning solvent.

The surfactant system and the organic grease cleaning solvent can be in a weight ratio of from 5:1 to 1:5, preferably from 4:1 to 1:2, most preferably 3:1 to 1:1. Compositions of use in the present invention, having such a weight ratio of surfactant system to organic solvent have been found to provide improved coverage on the dishware with minimum over-spray (residual spray droplets remaining in suspension in the air). Therefore, such spray compositions reduce wastage and minimise the amount of spray droplets which can be inhaled. Compositions having a surfactant:solvent weight ratio lower than 1:5 have been found to be less foaming and/or have a greater tendency to phase separate over time. Compositions having a surfactant:solvent weight ratio higher than 5:1 are typically more difficult to spray and are more prone to gelling when sprayed onto greasy soils, when the soil is not first wetted. Such gel formation inhibits the spreading of the composition onto the greasy surface and hence leads to less satisfactory cleaning.

Suitable glycol ether solvents can be selected from the group consisting of:
a) Formula I: R1(R2O)nR3,
   R1 is a linear or branched C4, C5 or C6 alkyl or a substituted or unsubstituted phenyl, R2 is ethyl or isopropyl, R3 is hydrogen or methyl and n is 1, 2 or 3;
b) Formula II: R4O(R5O)nR6,
   R4 is n-propyl or isopropyl, R5 is isopropyl, R6 is hydrogen or methyl and n is 1, 2 or 3; and
c) mixtures thereof

Suitable alcohol solvents can be selected from the group consisting of: C4-C6 linear mono-alcohols, branched C4-C10 mono-alcohols having one or more C1-C4 branching groups, alkyl mono-glycerols, and mixtures thereof

Suitable ester solvents can be selected from the group consisting of glycol ethers of:
a) monoesters having the formula R1C═OOR2, wherein R1 is a linear or branched C1 to C4 alkyl, and R2 is a linear or branched C2 to C8 alkyl;
b) di- or tri-esters having the formula R1(C═OOR2)n, R1 is a saturated or unsaturated C2 to C4 alkyl, R2 is independently selected from a linear or branched C2 to C8 alkyl, and n is 2 or 3;
c) benzylbenzoate; and
d) mixtures thereof.

Suitable glycol ether solvents can be selected from glycol ethers of Formula I, Formula II, and mixtures thereof:
a) Formula I=R1O(R2O)nR3
wherein
R1 is a linear or branched C4, C5 or C6 alkyl, a substituted or unsubstituted phenyl, preferably n-butyl. Benzyl is one of the substituted phenyls for use herein.

R2 is ethyl or isopropyl, preferably isopropyl
R3 is hydrogen or methyl, preferably hydrogen
n is 1, 2 or 3, preferably 1 or 2
b) Formula II=R4O(R5O)nR6
wherein
R4 is n-propyl or isopropyl, preferably n-propyl
R5 is isopropyl
R6 is hydrogen or methyl, preferably hydrogen
n is 1, 2 or 3 preferably 1 or 2

Suitable glycol ether solvents according to Formula I include ethyleneglycol n-butyl ether, diethyleneglycol n-butyl ether, triethyleneglycol n-butyl ether, propyleneglycol n-butyl ether, dipropyleneglycol n-butyl ether, tripropyleneglycol n-butyl ether, ethyleneglycol n-pentyl ether, diethyleneglycol n-pentyl ether, triethyleneglycol n-pentyl ether, propyleneglycol n-pentyl ether, dipropyleneglycol n-pentyl ether, tripropyleneglycol n-pentyl ether, ethyleneglycol n-hexyl ether, diethyleneglycol n-hexyl ether, triethyleneglycol n-hexyl ether, propyleneglycol n-hexyl ether, dipropyleneglycol n-hexyl ether, tripropyleneglycol n-hexyl ether, ethyleneglycol phenyl ether, diethyleneglycol phenyl ether, triethyleneglycol phenyl ether, propyleneglycol phenyl ether, dipropyleneglycol phenyl ether, tripropyleneglycol phenyl ether, ethyleneglycol benzyl ether, diethyleneglycol benzyl ether, triethyleneglycol benzyl ether, propyleneglycol benzyl ether, dipropyleneglycol benzyl ether, tripropyleneglycol benzyl ether, ethyleneglycol isobutyl ether, diethyleneglycol isobutyl ether, triethyleneglycol isobutyl ether, propyleneglycol isobutyl ether, dipropyleneglycol isobutyl ether, tripropyleneglycol isobutyl ether, ethyleneglycol isopentyl ether, diethyleneglycol isopentyl ether, triethyleneglycol isopentyl ether, propyleneglycol isopentyl ether, dipropyleneglycol isopentyl ether, tripropyleneglycol isopentyl ether, ethyleneglycol isohexyl ether, diethyleneglycol isohexyl ether, triethyleneglycol isohexyl ether, propyleneglycol isohexyl ether, dipropyleneglycol isohexyl ether, tripropyleneglycol isohexyl ether, ethyleneglycol n-butyl methyl ether, diethyleneglycol n-butyl methyl ether triethyleneglycol n-butyl methyl ether, propyleneglycol n-butyl methyl ether, dipropyleneglycol n-butyl methyl ether, tripropyleneglycol n-butyl methyl ether, ethyleneglycol n-pentyl methyl ether, diethyleneglycol n-pentyl methyl ether, triethyleneglycol n-pentyl methyl ether, propyleneglycol n-pentyl methyl ether, dipropyleneglycol n-pentyl methyl ether, tripropyleneglycol n-pentyl methyl ether, ethyleneglycol n-hexyl methyl ether, diethyleneglycol n-hexyl methyl ether, triethyleneglycol n-hexyl methyl ether, propyleneglycol n-hexyl methyl ether, dipropyleneglycol n-hexyl methyl ether, tripropyleneglycol n-hexyl methyl ether, ethyleneglycol phenyl methyl ether, diethyleneglycol phenyl methyl ether, triethyleneglycol phenyl methyl ether, propyleneglycol phenyl methyl ether, dipropyleneglycol phenyl methyl ether, tripropyleneglycol phenyl methyl ether, ethyleneglycol benzyl methyl ether, diethyleneglycol benzyl methyl ether, triethyleneglycol benzyl methyl ether, propyleneglycol benzyl methyl ether, dipropyleneglycol benzyl methyl ether, tripropyleneglycol benzyl methyl ether, ethyleneglycol isobutyl methyl ether, diethyleneglycol isobutyl methyl ether, triethyleneglycol isobutyl methyl ether, propyleneglycol isobutyl methyl ether, dipropyleneglycol isobutyl methyl ether, tripropyleneglycol isobutyl methyl ether, ethyleneglycol isopentyl methyl ether, diethyleneglycol isopentyl methyl ether, triethyleneglycol isopentyl methyl ether, propyleneglycol isopentyl methyl ether, dipropyleneglycol isopentyl methyl ether, tripropyleneglycol isopentyl methyl ether, ethyleneglycol isohexyl methyl ether, diethyleneglycol isohexyl methyl ether, triethyleneglycol isohexyl methyl ether, propyleneglycol isohexyl methyl ether, dipropyleneglycol isohexyl methyl ether, tripropyleneglycol isohexyl methyl ether, and mixtures thereof.

Preferred glycol ether solvents according to Formula I are ethyleneglycol n-butyl ether, diethyleneglycol n-butyl ether, triethyleneglycol n-butyl ether, propyleneglycol n-butyl ether, dipropyleneglycol n-butyl ether, tripropyleneglycol n-butyl ether, and mixtures thereof.

The most preferred glycol ether solvents according to Formula I are propyleneglycol n-butyl ether, dipropyleneglycol n-butyl ether, and mixtures thereof.

Suitable glycol ether solvents according to Formula II include propyleneglycol n-propyl ether, dipropyleneglycol n-propyl ether, tripropyleneglycol n-propyl ether, propyleneglycol isopropyl ether, dipropyleneglycol isopropyl ether, tripropyleneglycol isopropyl ether, propyleneglycol n-propyl methyl ether, dipropyleneglycol n-propyl methyl ether, tripropyleneglycol n-propyl methyl ether, propyleneglycol isopropyl methyl ether, dipropyleneglycol isopropyl methyl ether, tripropyleneglycol isopropyl methyl ether, and mixtures thereof.

Preferred glycol ether solvents according to Formula II are propyleneglycol n-propyl ether, dipropyleneglycol n-propyl ether, and mixtures thereof.

The most preferred glycol ether solvents are propyleneglycol n-butyl ether, dipropyleneglycol n-butyl ether, and mixtures thereof, especially dipropyleneglycol n-butyl ether.

Suitable glycol ether solvents can be purchased from The Dow Chemical Company, in particularly from the E-series (ethylene glycol based) Glycol Ether and the P-series (propylene glycol based) Glycol Ether line-ups. Suitable glycol ether solvents include Butyl Carbitol, Hexyl Carbitol, Butyl Cellosolve, Hexyl Cellosolve, Butoxytriglycol, Dowanol Eph, Dowanol PnP, Dowanol DPnP, Dowanol PnB, Dowanol DPnB, Dowanol TPnB, Dowanol PPh, and mixtures thereof.

Suitable alcohols can be selected from the group consisting of C4-C6 linear mono-alcohols, branched C4-C10 mono-alcohols having one or more C1-C4 branching groups, alkyl mono-glycerols, and mixtures thereof.

Preferred C4-C6 linear mono-alcohols are selected from pentanol, hexanol, and mixtures thereof, preferably 1-pentanol, 1-hexanol, and mixtures thereof.

Preferred branched C4-C10 mono-alcohols having one or more C1-C4 branching groups for use herein are C4-C8 primary mono-alcohols having one or more C1-C4 branching groups, and mixtures thereof. Especially preferred branched C4-C10 mono-alcohols having one or more C1-C4 branching groups for use herein include methyl butanol, ethyl butanol, methyl pentanol, ethyl pentanol, methyl hexanol, ethyl hexanol, propyl hexanol, dimethyl hexanol trimethyl hexanol, methyl hepanol, ethyl heptanol, propyl heptanol, dimethyl heptanol, trimethyl heptanol, methyl octanol, ethyl octanol, propyl octanol, butyl octanol, dimethyl octanol, trimethyl octanol, methyl nonanol, ethyl nonanol, propyl nonanol, butyl nonanol, dimethyl nonanol and trimethyl nonanol, and mixtures thereof. More preferred for use herein are the primary 1-alcohol member of branched C4-C10 mono-alcohols having one or more C1-C4 branching groups, especially preferred are the primary 1-alcohol family members of methyl butanol, ethyl butanol, methyl pentanol, ethyl pentanol, methyl hexanol, ethyl hexanol, propyl hexanol, dimethyl hexanol trimethyl hexanol, methyl hepanol, ethyl heptanol, propyl heptanol, dimethyl heptanol, trimethyl heptanol, methyl octanol, ethyl octanol, propyl octanol, butyl octanol, dimethyl octanol, trimethyl octanol, methyl nonanol, ethyl nonanol, propyl nonanol, butyl nonanol, dimethyl nonanol, trimethyl nonanol, and mixtures thereof.

More preferred alcohols are butyl octanol, trimethyl hexanol, ethyl hexanol, propyl heptanol, methyl butanol, and mixtures thereof, in particular the primary 1-alcohol family member, more in particular ethyl hexanol, butyl octanol, trimethyl hexanol, and mixtures thereof, especially 2-ethyl-1-hexanol, 2-butyl-1-octanol, 3,5,5 trimethyl-1-hexanol, and mixtures thereof.

Preferred alkyl mono-glycerols are selected from the group consisting of branched alkyl mono-glycerols and mixtures thereof, more preferably branched C4-C8 alkyl mono-glycerols with one or more C1 to C4 alkyl branching groups, more preferably selected from the group consisting of ethylhexylglycerol, propylheptylglycerol, and mixtures thereof, most preferably 2-ethylhexylglycerol.

Such alcohols can also improve sudsing.

Especially preferred for use herein are mixtures of mono-alcohols, in particular mixtures comprising a branched C4-C10 mono-alcohol, more in particular mixtures comprising an alcohol selected from the group comprising C4-C8 more preferably C6-C7 branched primary alcohols. Preferably for use is a mixture of alcohols comprising an alcohol selected from the group comprising C4-C8 branched primary alcohols with an alcohol selected of the group of C4-C6 linear mono-alcohols and alkylglycerols. Such mixtures can boost foaming and improve cleaning of various oily soils.

Suitable ester solvents can be selected from the group consisting of monoester solvents of Formula III, di- or triester solvents of formula IV, benzylbenzoate, and mixtures thereof.
a) Monoester solvents of formula III: R1C═OOR2, wherein:
   R1 is a linear of branched C1 to C4 alkyl, preferably a linear or branched C2 to C3 alkyl;
   R2 is a linear or branched C2 to C8 alkyl, preferably a linear or branched C2 to C6 alkyl, most preferably a linear of branched C3 to C4 alkyl;
b) Di- or triester solvents of formula IV: R1(C═OOR2)n, wherein:
   R1 is a saturated or unsaturated C2 to C4 alkyl;
   R2 is independently selected from a linear or branched C2 to C8 alkyl, preferably a linear or branched C2 to C6 alkyl, most preferably a linear of branched C3 to C4 alkyl;

n is 2 or 3 preferably 2;

Suitable monoester solvents of formula III include but are not limited to ethylacetate, propylacetate, isopropyl acetate, butylacetate, isobutylacetate, amylacetate, isoamyl acetate, hexylacetate, isohexylacetate, heptylacetate, isoheptylacetate, octylacetate, isooctylacetate, 2-ethylhexylacetate, ethylpropionate, propylpropionate, isopropylpropionate, butylpropionate, isobutylpropionate, amylpropionate, isoamylpropionate, hexylpropionate, isohexylpropionate, heptylpropionate, isoheptylpropionate, octylpropionate, isooctylpropionate, 2-ethylhexylpropionate, ethylbutyrate, propylbutyrate, isopropylbutyrate, butylbutyrate, isobutylbutyrate, amylbutyrate, isoamylbutyrate, hexylbutyrate, isohexylbutyrate, heptylbutyrate, isoheptylbutyrate, octylbutyrate, isooctylbutyrate, 2-ethylhexylbutyrate, ethylisobutyrate, propylisobutyrate, isopropylisobutyrate, butylisobutyrate, isobutylisobutyrate, amylisobutyrate, isoamylisobutyrate, hexylisobutyrate, isohexylisobutyrate, heptylisobutyrate, isoheptylisobutyrate, octylisobutyrate, isooctylisobutyrate, 2-ethylhexylisobutyrate, ethylpentanoate, propylpentanoate, isopropylpentanoate, butylpentanoate, isobutylpentanoate, amylpentanoate, isoamylpentanoate, hexylpentanoate, isohexylpentanoate, heptylpentanoate, isoheptylpentanoate, octylpentanoate, isooctylpentanoate, 2-ethylhexylpentanoate, ethylisopentanoate, propylisopentanoate, isopropylisopentanoate, butylisopentanoate, isobutylisopentanoate, amylisopentanoate, isoamylisopentanoate, hexylisopentanoate, isohexylisopentanoate, heptylisopentanoate, isoheptylisopentanoate, octylisopentanoate, isooctylisopentanoate, 2-ethylhexylisopentanoate, and mixtures thereof.

Preferred monoester solvents of formula III can be selected from the group consisting of ethylpropionate, propylpropionate, isopropylpropionate, butylpropionate, isobutylpropionate, amylpropionate, isoamylpropionate, hexylpropionate, isohexylpropionate, ethylbutyrate, propylbutyrate, isopropylbutyrate, butylbutyrate, isobutylbutyrate, amylbutyrate, isoamylbutyrate, hexylbutyrate, isohexylbutyrate, ethylisobutyrate, propylisobutyrate, isopropylisobutyrate, butylisobutyrate, isobutylisobutyrate, amylisobutyrate, isoamylisobutyrate, hexylisobutyrate, isohexylisobutyrate, and mixtures thereof.

Most preferably, the monoester solvents are selected from the group consisting of propylpropionate, isopropylpropionate, butylpropionate, isobutylpropionate, propylbutyrate, isopropylbutyrate, butylbutyrate, isobutylbutyrate, propylisobutyrate, isopropylisobutyrate, butylisobutyrate, isobutylisobutyrate, and mixtures thereof.

Suitable di- or tri-ester solvents of formula IV can be selected from: ethyl-, propyl-, isopropyl-, butyl-, isobutyl-, amyl-, isoamyl-, hexyl-, isohexyl-, heptyl-, isoheptyl, octyl-, isooctyl-, 2-ethylhexy- di- or tri-esters of succinic acid, glutaric acid, adipic acid, maleic acid, fumaric acid, glutaconic acid, citric acid, aconitic acid, propane-1,2,3-tricarboxylic acid, and mixtures thereof.

Preferred di- or tri-ester solvents are selected from the group consisting of ethyl-, propyl-, isopropyl-, butyl-, isobutyl-, amyl-, isoamyl-,hexyl-, isohexyl- di- or tri-esters of succinic acid, glutaric acid, adipic acid, maleic acid, fumaric acid, glutaconic acid, citric acid, aconitic acid, propane-1,2,3-tricarboxylic acid, and mixtures thereof

More preferably, the di- or tri-ester solvents are selected from the group consisting of ethyl-, propyl-, isopropyl-, butyl-, isobutyl- di- or tri-esters of succinic acid, glutaric acid, adipic acid, maleic acid, fumaric acid, glutaconic acid, citric acid, aconitic acid, propane-1,2,3-tricarboxylic acid, and mixtures thereof.

### Chelant

The composition herein may optionally further comprise a chelant at a level of from 0.1% to 10%, preferably from 0.2% to 5%, more preferably from 0.2% to 3%, most preferably from 0.5% to 1.5% by weight of the composition.

Suitable chelating agents can be selected from the group consisting of amino carboxylates, amino phosphonates, polyfunctionally-substituted aromatic chelating agents and mixtures thereof.

Amino carboxylates include ethylenediaminetetra-acetates, N-hydroxyethylethylenediaminetriacetates, nitrilo-triacetates, ethylenediamine tetraproprionates, triethylenetetraaminehexacetates, diethylenetriaminepentaacetates, and ethanoldiglycines, alkali metal, ammonium, and substituted ammonium salts therein and mixtures therein, as well as MGDA (methyl-glycine-diacetic acid), and salts and derivatives thereof and GLDA (glutamic-N,N- diacetic acid) and salts and derivatives thereof. GLDA (salts and derivatives thereof) is especially preferred according to the invention, with the tetrasodium salt thereof being especially preferred.

### Builder

The composition herein may comprise a builder, preferably a carboxylate builder. Salts of carboxylic acids useful herein include salts of C1-6 linear or at least 3 carbon containing cyclic acids. The linear or cyclic carbon-containing chain of the carboxylic acid or salt thereof may be substituted with a substituent group selected from the group consisting of hydroxyl, ester, ether, aliphatic groups having from 1 to 6, more preferably 1 to 4 carbon atoms, and mixtures thereof.

Preferred salts of carboxylic acids are those selected from the salts from the group consisting of salicylic acid, maleic acid, acetyl salicylic acid, 3 methyl salicylic acid, 4 hydroxy isophthalic acid, dihydroxyfumaric acid, 1,2, 4 benzene tricarboxylic acid, pentanoic acid, citric acid, and mixtures thereof, preferably citric acid.

Alternative carboxylate builders suitable for use in the composition of the invention includes salts of fatty acids like palm kernel derived fatty acids or coconut derived fatty acid, or salts of polycarboxylic acids.

The cation of the salt is preferably selected from alkali metal, alkaline earth metal, monoethanolamine, diethanolamine or triethanolamine and mixtures thereof, preferably sodium.

The carboxylic acid or salt thereof, when present, is preferably present at the level of from 0.05% to 5%, more preferably from 0.1% to 1% by weight of the total composition.

### Hydrotropes

The composition according to the invention might further comprise a hydrotrope. Preferably the hydrotrope is selected from cumene sulphonate, xylene sulphonate, toluene sulphonate, most preferably sodium neutralized cumene sulphonate. When present the hydrotrope is formulated from 0.1% to 5%, preferably from 0.25% to 3%, most preferably from 0.5% to 2% by weight of the detergent composition.

### Shear Thinning Rheology Modifier

The composition according to the invention might further comprise a rheology modifying agent, providing a shear thinning rheology profile to the product. Formulating with a rheology modifying polymer can improve particle size distribution of the resultant spray, as well as mitigating any stinging effect of the spray droplets. Preferably the rheology modifying agent is a non crystalline polymeric rheology modifier. This polymeric rheology modifier can be a synthetic or a naturally derived polymer.

Examples of naturally derived polymeric structurants of use in the present invention include: hydroxyethyl cellulose, hydrophobically modified hydroxyethyl cellulose, carboxymethyl cellulose, polysaccharide derivatives and mixtures thereof. Polysaccharide derivatives include but are not limited to pectine, alginate, arabinogalactan (gum Arabic), carrageenan, gum karaya, gum tragacanth, gellan gum, xanthan gum and guar gum. Examples of synthetic polymeric structurants of use in the present invention include polymers and copolymers comprising polycarboxylates, polyacrylates, polyurethanes, polyvinylpyrrolidone, polyols and derivatives and mixtures thereof. Alternatively the composition of use in the invention can comprise a polyethylenoxide (PEO) polymer.

Preferably the composition according to the invention comprises a rheology modifying polymer selected from a naturally derived rheology modifying polymer, most preferably Xanthan Gum, a polyethylenoxide, or mixtures thereof.

Generally, the rheology modifying polymer will be comprised at a level of from 0.001% to 1% by weight, alternatively from 0.01% to 0.5% by weight, more alternatively from 0.05% to 0.25% by weight of the composition.

### Cyclic Polyamine

The compositions of the present invention can comprise a cleaning amine such as a cyclic cleaning polyamine to further strengthen the overall grease cleaning performance. The term “cyclic polyamine” herein encompasses a single cleaning cyclic polyamine and a mixture thereof. The amine can be subjected to protonation depending on the pH of the cleaning medium in which it is used. Especially preferred for use herein are cyclic diamines selected from the group consisting of 1, 3-bis(methylamine)-cyclohexane, 2-methylcyclohexane-1,3-diamine, 4-methylcyclohexane-1,3-diamine and mixtures thereof. 1, 3-bis(methylamine)-cyclohexane is especially preferred for use herein. Mixtures of 2-methylcyclohexane-1,3-diamine, 4-methylcyclohexane-1,3-diamine are also preferred for use herein. Generally, the cyclic polyamine will be comprised at a level of from 0.1% to 5% by weight, alternatively from 0.2% to 2% by weight, more alternatively from 0.25% to 1% by weight of the composition.

### Other Adjunct Ingredients

The composition herein may comprise a number of optional ingredients such as rheology trimming agents or phase stabilizing agents selected from inorganic salts preferably sodium chloride, C2-C4 alcohols, C2-C4 polyols, poly alkylene glycols and especially polypropyleneglycols having a weight average molecular weight of from 1500 to 4,000, and mixtures thereof.

The composition might also comprise pH trimming and/or buffering agents such as sodium hydroxyde, alkanolamines including monoethanolamine, and bicarbonate inorganic salts.

The composition might comprise further minor ingredients selected from preservatives, UV stabilizers, antioxidants, perfumes, coloring agents and mixtures thereof.

### Spray Dispenser

The spray dispenser comprises a reservoir to accommodate the composition of the invention and spraying means. Suitable spray dispensers include hand pump (sometimes referred to as “trigger”) devices, pressurized can devices, electrostatic spray devices, etc. Preferably the spray dispenser is non-pressurized and the spray means are of the trigger dispensing type. The reservoir is typically a container such as a bottle, more typically a plastic bottle.

The cleaning product of the invention includes the cleaning composition. The cleaning composition is typically suitable for spraying from the spray dispenser onto the dish surface to be treated (“direct application”). The composition preferably forms a foam on the surface immediately upon application without requiring any additional physical (e.g., manual rubbing) intervention.

The spray dispenser typically comprises a trigger lever which, once depressed, activates a small pump. The main moving element of the pump is typically a piston, housed inside a cylinder, with the piston pressing against a spring. By depressing the trigger, the piston is pushed into the cylinder and against the spring, compressing the spring, and forcing the composition contained within the pump out of a nozzle. Once the trigger lever is released, the spring pushes the piston back out, expanding the cylinder area, and sucking the composition from the reservoir, typically through a one-way valve, and refilling the pump. This pump is typically attached to a tube that draws the composition from the reservoir into the pump. The spray dispenser can comprise a further one-way valve, situated between the pump and the nozzle.

The nozzle comprises an orifice through which the composition is dispensed. The nozzle utilises the kinetic energy of the composition to break it up into droplets as it passes through the orifice. Suitable nozzles can be plain, or shaped, or comprise a swirl chamber immediately before the orifice. Such swirl chambers induce a rotary fluid motion to the composition which causes swirling of the composition in the swirl chamber. A film is discharged from the perimeter of the orifice which typically results in dispensing the composition from the orifice as finer droplets.

Since such trigger-activated spray dispensers comprise a pump, the composition preferably is not pressurized within the reservoir and preferably does not comprise a propellant.

The spray dispenser can be a pre-compression sprayer which comprises a pressurized buffer for the composition, and a pressure-activated one-way valve between the buffer and the spray nozzle. Such precompression sprayers provide a more uniform spray distribution and more uniform spray droplet size since the composition is sprayed at a more uniform pressure. Such pre-compression sprayers include the Flairosol® spray dispenser, manufactured and sold by Afa Dispensing Group (The Netherlands) and the pre-compression trigger sprayers described in U.S. Patent Publication Nos. 2013/0112766 and 2012/0048959.

### Method of Use

The cleaning products, as described herein, are particularly suited for methods of cleaning dishware comprising the steps of: optionally pre-wetting the dishware; spraying the cleaning composition onto the dishware; optionally scrubbing the dishware; and rinsing the dishware.

The cleaning products described herein are particularly effective at loosening soils, and especially greasy soils. As such, especially for light soiling, scrubbing is optional, and particularly when the dishware is left for at least 15 seconds, preferably at least 30 seconds after the spray step, before the rinsing step is done. The cleaning products described herein are also particularly effective in facilitating a faster foam rinsing.

The steps of scrubbing of the dishware and rinsing the dishware can take place at least partially simultaneously, for example, by scrubbing the dishware under running water or when the dishware is submerged in water. The scrubbing step can take between 1 second and 30 seconds.

The present method allows for faster and easier cleaning of dishware when the dishware is lightly soiled. When the dishware is heavily soiled with tough food soils such as cooked-, baked- or burnt-on soils, the present method facilitates the cleaning when the soiled dishware is soaked with the product of the invention in neat form or diluted in water, preferably for a period of from 1 second to 30 seconds, or longer.

### METHODS

### A) Reserve Alkalinity

Reserve alkalinity is defined as the grams of NaOH per 100 g of composition required to titrate the test composition at pH 7.0 to come to the test composition pH. The reserve alkalinity for a solution is determined in the following manner.

A pH meter (for example An Orion Model 720A) with a Ag/AgCl electrode (for example an Orion sure flow Electrode model 9172BN) is calibrated using standardized pH 7 and pH 10 buffers. A 100 g of a 10% solution in distilled water at 20° C. of the composition to be tested is prepared. The pH of the 10% solution is measured and the 100 g solution is titrated down to pH 10 using a standardized solution of 0.1 N of HC1. The volume of 0.1N HC1 required is recorded in ml. The reserve alkalinity is calculated as follows:

Reserve Alkalinity=ml 0.1N HCl×0.1 (equivalent/liter)×Equivalent weight NaOH (g/equivalent)×10

### B) Viscosity

The rheology profile is measured using a “TA instruments DHR1” rheometer, using a cone and plate geometry with a flat steel Peltier plate and a 60 mm diameter, 2.026° cone (TA instruments, serial number: SN960912). The viscosity measurement procedure includes a conditioning step and a sweep step at 20° C. The conditioning step consists of a 10 seconds at zero shear at 20° C., followed by pre-shearing for 10 seconds at 10 s⁻¹ at 20° C., followed by 30 seconds at zero shear at 20° C. in order for the sample to equilibrate. The sweep step comprises a logarithmical shear rate increase in log steps starting from 0.01 s⁻¹ to 3,000 s⁻¹ at 20° C., with a 10 points per decade acquisition rate taken in a sample period of 15 s, after a maximum equilibration time of 200 seconds (determined by the rheometer, based on a set tolerance of 3%). When measuring shear thinning product compositions, the high shear viscosity is defined at a shear rate of 1,000 s⁻¹, and the low shear viscosity at a shear rate of 0.1 s⁻¹. For Newtonian product compositions the shear rate is recorded at 1,000 s⁻¹.

### C) Foam Rinsing Test Method

9 Falcon tubes (50 ml) are individually mounted at the same time in a 9 placeholder rack to allow parallel measurements with matching exposure conditions.
1. Circa 4.5 g of a test detergent composition is sprayed directly into a Falcon tube through 3 times spraying a Flairosol type spray trigger, as commercially available from the AFA company and used in Dawn Powerwash spray product, as commercially available in the US in October 2020. The Falcon tube is placed on a flat surface under an angle of 15 degrees versus that flat surface (upright placement of the Falcon tube corresponding to 90 degrees). The tip of the spraying nozzle is positioned 1 cm away from the Falcon tube opening, and the spray bottle is tilted 15 degrees away from the upright position such that the spraying is directed through the Falcon tube opening towards the bottom rather than towards the side walls of the Falcon tube. The exact amount of product sprayed is weighed and recorded.
2. The initial suds volume is recorded 30 seconds after spraying and placement of the Falcon tube in the rack, e.g. at equilibrated liquid levels.
3. The liquid is hence decanted such that only suds remains.
4. Then the suds comprising falcon tubes are gently filled via a Dispensette via the tube wall with 10 mL water rinse solution at a given temperature and water hardness.
5. The tubes are shaken all together by moving the rack 2× in a vertical up and down direction at a speed of 2 strokes per second (1 stroke reflects a 25 cm vertical up or down movement), such that the liquid contacts once with the screw cap during each 2 stroke movement step.
6. Within 30s, e.g. at equilibrated liquid levels, the suds volume is re-determined and liquid decanted. Steps 4 till 6 represent a rinse cycle.
7. Rinse cycles are repeated till no suds left with a maximum of 20 cycles.
8. Tests were repeated twice using 2 different triggers for each rinse condition. 2 different water hardness (2dH and 15 dH) and 2 different water temperatures (25° C. and 35° C.) were tested as rinsing conditions. Test results and actual product amount sprayed were consequently averaged across test conditions and replicates. Averaged suds volumes have been recalculated in function of actual averaged amount of product sprayed, and as such are expressed as suds volume per gram of sprayed product.

### EXAMPLES

The improvement in suds volume, suds mileage and rinse effort for inventive spray compositions comprising the non-alkoxylated esteramine can be seen from the data below.

The following compositions were prepared through standard mixing of the individual raw materials.

Inventive compositions 1 to 3 comprised essentially the same level of anionic surfactant (alkyl ethoxy sulfate and linear alkyl benzene sulfonate), nonionic surfactant (alcohol ethoxylate) and amphoteric surfactant (amine oxide surfactant). The compositions had slight differences in the level of HLAS to at least partially compensate for the slight differences in amounts of LAS introduced as part of the salt form of the non-alkoxylated esteramine.

Comparative example A comprised the same level of alkyl ethoxy sulfate and amine oxide surfactant as examples 1 to 3. Comparative example A contained an additional 1% of C10-14 HLAS, in order to compensate for the neutralising LAS introduced to the formula with the esteramines in the inventive examples. Comparative example B has the same composition as comparative example A, but comprised 1.0% of alternative cleaning amine (methylcyclohexane-1,3-diamine). As such, comparative example B comprised a higher level of a cleaning amine than inventive examples 1 to 3.

All of the compositions provided an initial suds volume of between 6.0 ml and 6.9 ml.

Table 1 also includes the resultant suds volume reduction after 7 rinse cycles and the number of rinse cycles to nil-suds, using the method described above.

TABLE 1
Liquid hand dishwashing spray detergent compositions
(inventive and comparative*):

| | Ex 1 | Ex 2 | Ex 3 | Ex A* | Ex B* |
|---|---|---|---|---|---|
| Wt % (100% active basis) | wt % | wt % | wt % | wt % | wt % |
| C12-C14 EO3.0S | 5.5 | 5.5 | 5.5 | 5.5 | 5.5 |
| C12-C14 dimethyl amine oxide | 3.5 | 3.5 | 3.5 | 3.5 | 3.5 |
| Linear C6 EO5 alcohol ethoxylate¹ | 4.0 | 4.0 | 4.0 | 4.0 | 4.0 |
| C10-C14 HLAS² | — | — | — | 1.0 | 1.0 |
| Tetrasodium glutamate diacetate | 1.0 | 1.0 | 1.0 | 1.0 | 1.0 |
| Citric acid | 0.1 | 0.1 | 0.1 | 0.1 | 0.1 |
| Dipropylene glycol n-butyl ether³ | 6.0 | 6.0 | 6.0 | 6.0 | 6.0 |
| Methylcyclohexane-1,3-diamine⁴ | — | — | — | — | 1.0 |
| 2-ethyl hexyl 6-aminohexanoate -LAS | 1.8 | — | — | — | — |
| of which: | | | | | |
| 2-ethyl hexyl caprolactam | (1.0) | | | | |
| C10-C14 LAS | (0.8) | | | | |
| n-butanol 6-aminohexanoate -LAS | — | 1.6 | — | — | — |
| of which: | | | | | |
| n-butanol caprolactam | | (1.0) | | | |
| C10-C14 LAS | | (0.6) | | | |
| n-octanol 6-aminohexanoate -LAS | — | — | 1.8 | — | — |
| of which: | | | | | |
| n-octanol caprolactam | | | (1.0) | | |
| C10-C14 LAS | | | (0.8) | | |
| monoethanolamine | 0.5 | 0.5 | 0.5 | 0.5 | 0.5 |
| Ethanol | 0.3 | 0.3 | 0.3 | 0.3 | 0.3 |
| Polypropylene glycol (MW2000) | 0.05 | 0.05 | 0.05 | 0.05 | 0.05 |
| perfume | 0.08 | 0.08 | 0.08 | 0.08 | 0.08 |
| Phenoxyethanol | 0.3 | 0.3 | 0.3 | 0.3 | 0.3 |
| water | to 100 | to 100 | to 100 | to 100 | to 100 |
| pH neat | 10.0 | 10.0 | 10.0 | 10.0 | 10.0 |
| % suds loss after 7 rinse cycles⁺ | 55 | 44 | 55 | 38 | 37 |

¹Lutensol CS6250, supplied by BASF
²to compensate for different amounts of LAS introduced with the non-alkoxylated esteramine.
³Dowanol DPNB glycol ether solvent, supplied by DOW
⁴Cyclic diamine mixture of 4-methylcyclohexane-1,3-diamine and 2-methylcyclohexane-1,3-diamine, supplied under the tradename Baxxodur EC 210 supplied by BASF
⁺higher the better

As can be seen from comparing the results of examples 1 to 3 with comparative example A, the incorporation of the esteramine results in an improved rinsability. Comparing the results from the compositions of examples 1 to 3 with example B, it can be seen that the improvement in rinsability is improved over compositions which comprise an alternative cleaning amine.

In table 2, the comparative test was repeated using compositions having a surfactant system which comprised nonionic surfactant (alkyl polyglucoside and alkyl ethoxylate) and amphoteric surfactant (amine oxide), in addition to a small amount of LAS surfactant to compensate for slight differences in the amount of LAS introduced as part of the neutralized non-alkoxylated esteramine.

Table 2 also includes the resultant suds volume reduction after 7 rinse cycles, using the method described above.

TABLE 2
Liquid hand dishwashing spray detergent
compositions (inventive and comparative*)

| | Ex 4 | Ex 5 | Ex 6 | Ex C* | Ex D* |
|---|---|---|---|---|---|
| Wt % (100% active basis) | wt % | wt % | wt % | wt % | wt % |
| C8-C18 alkyl polyglucoside | 3.5 | 3.5 | 3.5 | 3.5 | 3.5 |
| C12-C14 dimethyl amine oxide | 3.5 | 3.5 | 3.5 | 3.5 | 3.5 |
| Linear C6 EO5 alcohol ethoxylate⁵ | 2.0 | 2.0 | 2.0 | 2.0 | 2.0 |
| C10-C14 HLAS² | — | — | — | 1.0 | 1.0 |
| Tetrasodium glutamate diacetate | 1.0 | 1.0 | 1.0 | 1.0 | 1.0 |
| Citric acid | 0.04 | 0.04 | 0.04 | 0.04 | 0.04 |
| Dipropylene glycol n-butyl ether³ | 4.0 | 4.0 | 4.0 | 4.0 | 4.0 |
| Methylcyclohexane-1,3-diamine⁴ | — | — | — | — | 1.0 |
| 2-ethyl hexyl 6-aminohexanoate -LAS | 1.8 | — | — | — | — |
| of which: | | | | | |
| 2-ethyl hexyl caprolactam | (1.0) | | | | |
| C10-C14 LAS | (0.8) | | | | |
| n-butanol 6-aminohexanoate -LAS | — | 1.6 | — | — | — |
| of which: | | | | | |
| n-butanol caprolactam | | (1.0) | | | |
| C10-C14 LAS | | (0.6) | | | |
| n-octanol 6-aminohexanoate -LAS | — | — | 1.8 | — | — |
| of which: | | | | | |
| n-octanol caprolactam | | | (1.0) | | |
| C10-C14 LAS | | | (0.8) | | |
| monoethanolamine | 0.5 | 0.5 | 0.5 | 0.5 | 0.5 |
| Ethanol | 0.3 | 0.3 | 0.3 | 0.3 | 0.3 |
| Sodium cumene sulphonate | 1.0 | 1.0 | 1.0 | 1.0 | 1.0 |
| Polypropylene glycol (MW2000) | 0.05 | 0.05 | 0.05 | 0.05 | 0.05 |
| perfume | 0.3 | 0.3 | 0.3 | 0.3 | 0.3 |
| Phenoxyethanol | 0.3 | 0.3 | 0.3 | 0.3 | 0.3 |
| water | to 100 | to 100 | to 100 | to 100 | to 100 |
| pH neat | 10.0 | 10.0 | 10.0 | 10.0 | 10.0 |
| % suds loss after 7 rinse cycles⁺ | 59 | 44 | 55 | 38 | 37 |

⁵Glucopon ® 600, supplied by BASF

As can be seen from the results in table 2, the improvement in rinsing is also present where the surfactant system comprises little or no anionic surfactant.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cleaning product comprising a spray dispenser and a cleaning composition suitable for spraying, the composition is housed in the spray dispenser, wherein the composition comprises a surfactant system, wherein the surfactant system comprises:
a) a non-alkoxylated esteramine, wherein the non-alkoxylated esteramine has the formula (I):
R¹—[CH₂)_{c}—O(O)C—R²—(NH₂₋ₐ)—(R3)ₐ—(NH2)ₐ]_{b} (I)
wherein:
R¹ is a branched or unbranched C₃-C₁₆ alkyl;
each R² is independently selected from branched or unbranched C₁-C₁₂ alkyl;
each R³ is independently selected from branched or unbranched C₁-C₁₂ alkyl;
each index a is about 0 or about 1;
the index b is an integer from about 1 to about 3; and
each index c is independently about 0 or about 1.

2. The product according to claim 1 wherein in the non-alkoxylated esteramine of formula (I), R¹ is a C₃-C₁₀ alkyl.

3. The product according to claim 2 wherein in the non-alkoxylated esteramine of formula (I), R¹ is a C₃-C₈ alkyl.

4. The product according to claim 1, wherein in the non-alkoxylated esteramine of formula (I), each R² is independently selected from C₂-C₈ alkyl.

5. The product according to claim 4, wherein in the non-alkoxylated esteramine of formula (I), each R² is independently selected from C₂-C₆ unbranched alkyl.

6. The product according to any of claim 1, wherein in the non-alkoxylated esteramine of formula (I):
a) each index a is about 0;
b) index b is an integer from about 1 to about 2;
c) each index c is about 0.

7. The product according to claim 1, wherein the non-alkoxylated esteramine is at least partially in salt form and coupled with charge-balancing anion A⁻, wherein A⁻ is an anion derived from an acid selected from the group consisting of methanesulfonic acid, toluene sulfonic acid, hydrochloric acid, hydrobromic acid, sulfuric acid, phosphoric acid, citric acid, lactic acid, C12-C18 fatty acid, alkyl benzene sulfonic acids, alkyl sulphonic acids, alkyl sulfuric acids, alkyl ethyoxysulfuric acids, alkoxylated or non-alkoxylated copolymers of acrylic acid and maleic acid, and mixtures thereof.

8. The product according to claim 1, wherein the non-alkoxylated esteramine is selected from the group consisting of: 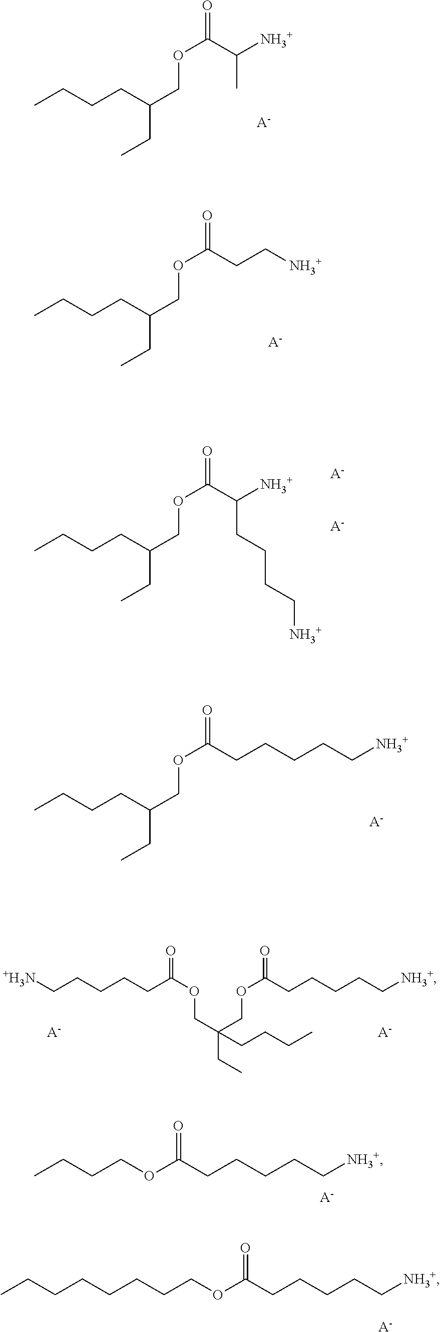
or a mixture thereof,
wherein the non-alkoxylated esteramine is present in its salt form or non-salt form, and
wherein, if present, A⁻ is a suitable charge-balancing anion.

9. The product according to claim 8, wherein the non-alkoxylated esteramine is selected from the group consisting of: 2-ethylhexyl 6-aminohexanoate and its salts, n-octyl 6-aminohexanoate and its salts, n-butyl 6-aminohexanoate and its salts, and mixtures thereof.

10. The product according to claim 1, wherein the surfactant system comprises from about 0.1% to about 10% by weight of the composition of the non-alkoxylated esteramine, wherein the weight percentage of the non-alkoxylated esteramine is based on the mass of the fully ionized cation of the non-alkoxylated esteramine, whether present in its salt form or non-salt form, and excluding the weight of the counterions.

11. The product according to claim 1, wherein the composition comprises from about 2.0% to about 25% by weight of the composition of the surfactant system.

12. The product according to claim 1, wherein the surfactant system further comprises a surfactant selected from the group consisting of: anionic surfactant, nonionic surfactant, and mixtures thereof.

13. The product according to claim 10, wherein the surfactant system comprises a surfactant which is an anionic surfactant selected from the group consisting of: linear alkyl benzene sulfonate, alkyl sulphated anionic surfactant, and mixtures thereof.

14. The product according to claim 11, wherein the surfactant system comprises the alkyl sulphate anionic surfactant at a level of from about 2.0% to about 12% by weight of the composition.

15. The product according to claim 10, wherein the surfactant system comprises a detersive surfactant which is a nonionic surfactant, wherein the nonionic surfactant is selected from the group consisting of: alkyl alkoxylate nonionic surfactant, alkyl polyglucoside surfactant, and mixtures thereof.

16. The product according to claim 15, wherein the surfactant system comprises a detersive surfactant which is a nonionic surfactant, wherein the nonionic surfactant is a blend of alkyl alkoxylate nonionic surfactant and alkyl polyglucoside surfactant.

17. The product according to claim 15, wherein the nonionic surfactant comprises an alkyl polyglucoside, wherein the alkyl polyglucoside is present at a level of from about 2.0% to about 12% by weight of the composition.

18. The product according to claim 15, wherein the nonionic surfactant comprises an alkyl alkoxylate nonionic surfactant, wherein the alkyl alkoxylate nonionic surfactant is present at a level of from about 0.5% to about 10% by weight of the composition.

19. The product according to claim 1, wherein the surfactant system comprises a co-surfactant selected from the group consisting of: amphoteric surfactant, zwitterionic surfactant, and mixtures thereof.

20. The product according to claim 16, wherein the co-surfactant is present at a level of from about 0.5% to about 5.0% by weight of the composition.
